(19) United States
(12) Patent Application Publication
(10) Pub. No.: US 2006/0181049 A1
(43) Pub. Date: Aug. 17, 2006

(54) Electronically-driven step for vehicle

(75) Inventors: Norikazu Kobayashi, Chita-shi (JP); Koji Aoki, Nagoya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/339,689

(22) Filed: Jan. 26, 2006

(30) Foreign Application Priority Data
Jan. 27, 2005 (JP) 2005-019297

(51) Int. Cl. B60R 3/00

(52) U.S. Cl. 280/166; 182/91; 182/127

(57) ABSTRACT

An electronically-driven step for a vehicle which is highly convenient for a user of the vehicle is provided. A step body which can be ejected and retracted between an ejected position projecting outwardly from a side surface of a vehicle body of the vehicle and a retracted position retracted inwardly of the side surface thereof; portable unit recognizing portion that recognizes movement of at least the portable unit toward the vehicle or apart from the vehicle; a step driving portion that causes the step body to be ejected or retracted; and step controlling portion that controls the step driving portion are provided, and the step controlling portion controls ejection and retraction of the step body on the basis of a recognized result of the portable unit recognizing portion.

### CROSS REFERENCES TO RELATED APPLICATIONS

This application is based on and claims priority under 35 U.S.C., Section 119 with respect to Japanese Patent Application No. 2005-019297 filed on Jan. 27th, 2005, the entire content of which is incorporated herein by reference.

### BACKGROUND OF THE INVENTION

1. Field of the Invention

The present invention relates to an electronically-driven step for a vehicle including a step body which can be retracted and ejected between an ejected position ejected outwardly from a side surface and a retracted position retracted inwardly from the side surface of a vehicle body of the vehicle, step driving means that causes the step body to be ejected and retracted, and step controlling means that controls the step driving means.

2. Description of the Related Art

The electronically-driven step for a vehicle as described above is ejected to an ejected position which is a working position when a user of the vehicle gets on and off the vehicle for assisting him/her to get on and off. In particular, in the case of RVs (Recreational Vehicles) or mini-vans whose ground clearance is high, provision of the step is increased since the height from the ground to the floor of the cabin is high. The step body is preferably adapted to be retracted to a retracted position when not in use, for example, during travel of the vehicle, so as not to be projected from the side surface or a rear surface of the vehicle body.

Japanese Unexamined Patent Application Publication No. 2003-127776 (1st and 8-12th paragraphs) discloses a technique relating to an electronically-driven step apparatus in which a step body is stored (retracted) and ejected in conjunction with opening and closing operations of a door of a motor vehicle. In this document, an example in which the step body is provided at a lower side of the door (platform) at a center of the side surface of the vehicle body of a mini-van is shown. When the door is opened, a door-open signal is applied to a motor via an electric circuit, so that the step body is ejected to be ready to use. When the door is closed, a corresponding signal is applied to the motor, so that the step body is stored.

In the case of the electronically-driven step disclosed in Japanese Unexamined Patent Application Publication No. 2003-127776, ejection and storage (retraction) of the step body is controlled in conjunction with the opening and closing of the door as described above. However, for example, when the door is opened from the outside of the vehicle, the user is already near a position where he/she can get on and off the vehicle. Therefore, when the step body is ejected in conjunction with the opening of the door, the user must wait until the step body is completely ejected before getting on or off. When the step body is caused to be ejected in a state in which the user is already nearby, the step body may come into contact with the user and hence there may be a case in which ejection of the step body is interfered or the user may feel irked.

The electronically-driven step which is activated only when the door is actually opened or closed as described above is desired to be improved in view of improvement of convenience of the user. In Japanese Unexamined Patent Application Publication No. 2003-127776, an example in which activation is also achieved not only by the opening and closing of the door, but also by a switch provided on an instrument panel at a driver's seat or at a seat is shown (see the 18th paragraph). However, when there is no one who can operate the switch, the step body is not ejected unless the user operates the door or the switch, which presents the same problem.

### SUMMARY OF THE INVENTION

In view of such a problem described above, it is an object of the present invention to provide an electronically-driven step for a vehicle which is convenient for a user of a vehicle.

In order to achieve the object, an electronically-driven step for a vehicle according to the present invention includes:

a step body which can be ejected and retracted between an ejected position projecting outwardly from a side surface of a vehicle body of the vehicle and a retracted position retracted inwardly of the side surface thereof;

portable unit recognizing means that recognizes movement of at least the portable unit toward the vehicle or apart from the vehicle by communication with the portable unit carried by a user;

step driving means that causes the step body to be ejected or retracted; and

step controlling means that controls the step driving means,

wherein the step controlling means controls ejection and retraction of the step body on the basis of a recognized result of the portable unit recognizing means.

In this arrangement, ejection and retraction of the step body can be controlled by communication with the portable unit carried by the user irrespective of whether the user actually operates a vehicle door or not. Therefore, ejection or retraction of the step body can be completed even when the user is not at a distance that the user can actually operate the vehicle door. Consequently, the user needs not to reach a position that the user can get on the vehicle and wait until the step body is ejected completely. Since the step body is already ejected when the user reaches the vehicle door, the step body being ejected is prevented from coming into contact with the user. Therefore, there is no possibility to hinder the step body from being ejected or to give the user an uncomfortable feeling. In this manner the electronically-driven step which is convenient for the user can be provided.

Another electronically-driven step for a vehicle according to the present invention includes:

a step body which can be ejected and retracted between an ejected position projecting outwardly from a side surface of a vehicle body of the vehicle and a retracted position retracted inwardly of the side surface thereof;

lock/unlock operating means that locks or unlocks a vehicle door;

lock/unlock instruction recognizing means that recognizes an instruction to the lock/unlock operating means;

step driving means that causes the step body to be ejected or retracted; and

step controlling means that controls the step driving means,

wherein the step controlling means controls ejection and retraction of the step body on the basis of a recognized result of the lock/unlock instruction recognizing means.

In this arrangement, irrespective of whether the user actually operates the vehicle door of the vehicle or not, ejection and retraction of the step body can be controlled by the door lock/unlock instruction. The lock/unlock instruction can be provided remotely by the use of a remote instruction means such as a remote controller or the like. Therefore, even when the user is not actually at a position that he/she can operate the vehicle door, ejection and retraction of the step body can be controlled. Consequently, the electrically-driven step which is convenient for the user can be provided.

Preferably, lock/unlock operating means that locks or unlocks the vehicle door and lock/unlock instruction recognizing means that recognizes instructions for the lock/unlock operating means are further provided, and

the step controlling means controls ejection and retraction of the step body on the basis of the recognized result or results of one or both of the portable unit recognizing means and the lock/unlock instruction recognizing means.

In this arrangement, ejection and retraction of the step body can be controlled by one or both of the recognition of the portable unit carried by the user or the recognition of vehicle door lock/unlock instruction irrespective of whether the user actually operated the vehicle door or not. Even in the case where ejection and retraction of the step body is controlled on the basis of either one of those described above, it is not necessary for the user to be at a distance that he/she can operate the vehicle door as already described. Therefore, ejection and retraction of the step body can be completed at a timing when the user operates the vehicle door. When control is made by the recognition of both of the portable unit and the lock/unlock instruction, further accurate control or control of a plurality of patterns depending on the combination thereof is applicable. Consequently, the electronically-driven step which is convenient for the user can be provided.

Preferably, the step body is adapted to be ejected when the fact that the portable unit is approaching the vehicle is recognized and to be retracted when the fact that the portable unit is moved apart from the vehicle is recognized.

With this control, approach of the user carrying the portable unit can be recognized and hence ejection of the step body can already be completed when the user reaches the vehicle, opens the door and gets on the vehicle. Therefore, since the user needs not to wait until the step body is ejected before getting on the vehicle, the convenient electronically-driven step can be provided. There is a case in which the user does not get on the vehicle and moves away from the vehicle even after approach of the user is recognized and the step body is ejected. With the aforementioned control, in such a case, the step body is retracted by recognizing that the user has moved apart from the vehicle. When the user gets off normally as well, the step body can be retracted by recognizing the fact that the user has moved apart from the vehicle, as a matter of course. Therefore, unintended ejection of the step body which may hinder passage of other people may be prevented when the user has moved apart from the vehicle and the vehicle is in a parked state. Consequently, the electronically-driven step which is convenient for the user and other people can be provided.

Preferably, the portable unit recognizing means detects the direction in which the portable unit is approaching, and the step controlling means causes the step body provided on the side where the portable unit is approaching to be ejected.

When the step bodies are provided corresponding to a plurality of doors of the vehicle, all the step bodies are not necessarily used simultaneously. Therefore, as described above, it is controlled to detect the direction in which the portable unit is approaching, and eject only the step body on the corresponding side. Accordingly, the step body which is not used is prevented from being operated and the step body which is highly likely to be used can reliably be operated out of the plurality of step bodies. Ejection and retraction of the step body by means of the electronic power is achieved by an actuator such as a motor. Therefore, by limiting ejection and retraction to the step body which is estimated to be used, the power consumption may be reduced.

The term “the plurality of doors” is not limited to the one provided on the side of the vehicle, but a rear door such as a hatchback is also included. The term “the step bodies corresponding to the plurality of doors” is not limited to the structure in which the doors and the step bodies are coordinated on one-by-one basis. For example, a structure in which a step body which corresponds both to front and rear doors and extends longitudinally on the side of the vehicle is also included.

Preferably, the step body is retracted after having elapsed a predetermined time period after the fact that the portable unit is moved apart from the vehicle is detected.

There is a case in which the user having the portable unit is on or near the boundary where the portable unit recognizing means can recognize the existence of the portable unit (approach or separation). In this case, the recognition of approach and separation may vary frequently according to the strength of a signal from a medium of communication such as the electric wave or the positional variation in association with the movement of the user. When ejection or retraction of the step body is performed in association with the recognized result which may be varied frequently, the motor or the like which drives the step body repeats switching in the unnecessary direction of rotation. This is not preferable from the viewpoint of power consumption or durability. Therefore, the step body is adapted so as not to be retracted when the separation is recognized as described above (when approach is not recognized). Accordingly, necessity of switching the direction of movement between ejection and retraction is preferably avoided.

Preferably, the portable unit recognizing means detects the direction in which the portable unit is approaching, and the step controlling means is adapted to cause the step body provided on the side where the portable unit is approaching to be ejected on the basis of the detected direction, and cause other step bodies to be ejected on the basis of the recognition of the unlock instruction from the lock/unlock instruction recognizing means.

When the step bodies are provided on the plurality of positions of the vehicle, all the step bodies are not necessarily used. Therefore, as described above, it is controlled so as to detect the direction in which the portable unit is approaching and causes only the step body provided on the corresponding side to be ejected. Accordingly, possibility to operate the step body which is not used is reduced, and the step body which is highly likely to be used out of the plurality of step bodies can reliably be operated.

When the vehicle is used by a plurality of users, the user carrying the portable unit (driver, for example) emits the door unlock instruction for doors other than the door that the driver uses for getting on and off the vehicle using the remote controller or the like in many cases. In such a case, the step bodies other than the step body to be ejected by the fact that the driver is approaching can be ejected on the basis of the unlock instruction. Consequently, in the case in which the vehicle is used by the plurality of users, a highly convenient electronically-driven step can be provided.

Preferably, the step body is caused to be ejected when the lock/unlock instruction recognizing means recognizes the unlock instruction, and caused to be retracted when the same recognizes the lock instruction.

When the unlock instruction is issued, the user has an intention to get on the vehicle in many cases, and when the lock instruction is issued, the user has an intention to get off and move apart from the vehicle in many cases. Therefore, with the aforementioned control, the step body can be ejected when the user gets on the vehicle and retracted after the user has completely gotten off the vehicle. The lock/unlock instructions can be provided remotely using the remote instruction means such as the remote controller. Therefore, the step body can be ejected and retracted even when the user is at a position apart from the vehicle. Consequently, the highly convenient electronically-driven step can be provided.

Preferably, open/close state detecting means that detects the open/close state of the respective vehicle doors is further provided, and the step controlling means causes the corresponding step body to be retracted according to a transition from the open state to the close state of each door.

When the door is changed from the open state to the close state in a state in which the step body corresponding thereto is projected, it is considered that the user has already gotten on or off the vehicle using that door. Since the getting on or off is completed, the step body does not need to be ejected any longer, and is preferable to be retracted to the retracted position. In the structure described above, the door open/close state detecting means is provided and the step body is retracted according to the transition of the door corresponding thereto from the open state to the close state. Therefore, unnecessary ejection of the step body is inhibited, and hence is prevented from hindering the passage while it is stopped or parked.

Preferably illumination means is provided and the illumination means is illuminated in conjunction with the step body being ejected.

With the provision of the illumination means which emits light in conjunction with the ejection of the step body, the state around the feet can be confirmed even in the case in which the underfooting of the user is dark such as during the nighttime or in an indoor parking. Even when paddles or muddy ground exist in the outdoor, contamination of the foot or contamination in the cabin due to the contamination of the foot can be prevented by improving the visibility. In particular, in the case of the RV or the like, since there are many cases that the user gets on and off the vehicle on an unpaved road, improvement of visibility as described above is preferable.

When a part which emits light is provided on the step body itself, the step body itself can also be confirmed by the illumination from a remote location. Consequently, guiding of the user to the vehicle can be achieved smoothly.

In addition, a footlight for the ground is an illumination below the vehicle body which is apt to be hidden by the vehicle body. Therefore, it can illuminate sufficiently even when the brightness is lowered. In particular, when the illumination is provided on the step body, the direction toward the ground is illuminated from the position closest to the ground out of the vehicle. Therefore, the brightness can be lowered in comparison with the case in which the illumination is provided at other parts of the vehicle. In this manner, the power consumption by the illumination can be reduced while ensuring sufficient visibility.

The vehicle may be provided with either one or both of the footlight and the illumination for making the step body visible.

### BRIEF DESCRIPTION OF THE DRAWINGS

FIG. 1 is an appearance drawing of a vehicle to which an electronically-driven step of the present invention is mounted, showing an example of arrangement of a step body thereof in an ejected state;

FIG. 2 is a block diagram showing a system structure of the electronically-driven step for a vehicle according to the embodiment of the present invention.

FIG. 3 is a state transition drawing showing a state of ejection/retraction of the step body of the electronically-driven step of the vehicle and transition conditions thereof according to the embodiment of the present invention.

### DESCRIPTION OF THE PREFERRED EMBODIMENTS

Referring now to the drawings, preferred embodiments of the present invention will be described.

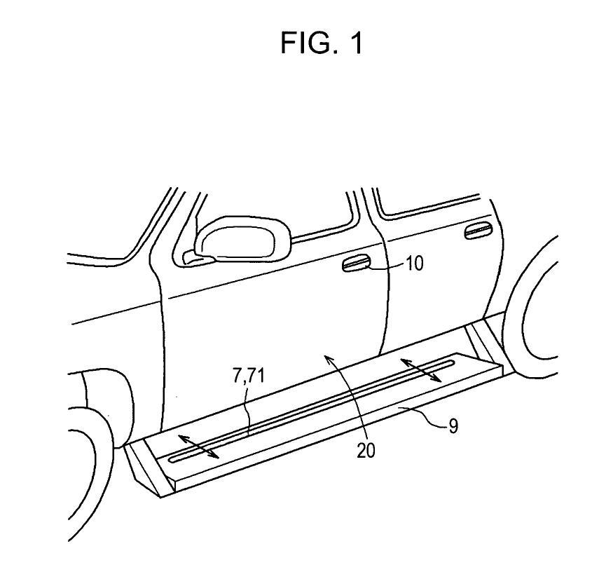

FIG. 1 is an appearance drawing of a vehicle 20 to which an electronically-driven step for a vehicle according to an embodiment of the present invention is mounted, showing an example of arrangement of a step body 9 thereof in an ejected state. The step body 9 is adapted to be capable of being ejected and retracted between an ejected position ejected outwardly from a side surface of a vehicle body of the vehicle 20 and a retracted position retracted inwardly from the side surface thereof. When being retracted, it is retracted under the vehicle body of the vehicle 20, and stored at a position which can hardly be viewed from a viewpoint of FIG. 1. When being ejected, it is pulled out to a state in which a user can use the same as a footstep when he/she gets on and off the vehicle as shown in FIG. 1. The step body 9 includes illumination means (which corresponds to an illumination device 7 and a step illumination 71 described later) for notifying the step body 9 itself on an upper surface thereof. Accordingly, it can conveniently notify the user that the step body 9 is ejected even in a dark place such as during nighttime or in an indoor parking. Although it is not shown in FIG. 1, the illumination means (which corresponds to a footlight 72 described later) is also provided on the lower surface side of the step body 9, so as to illuminate the ground. Accordingly, even in the dark place, the user can view a state of the ground such as paddles, muddy ground, or steps.

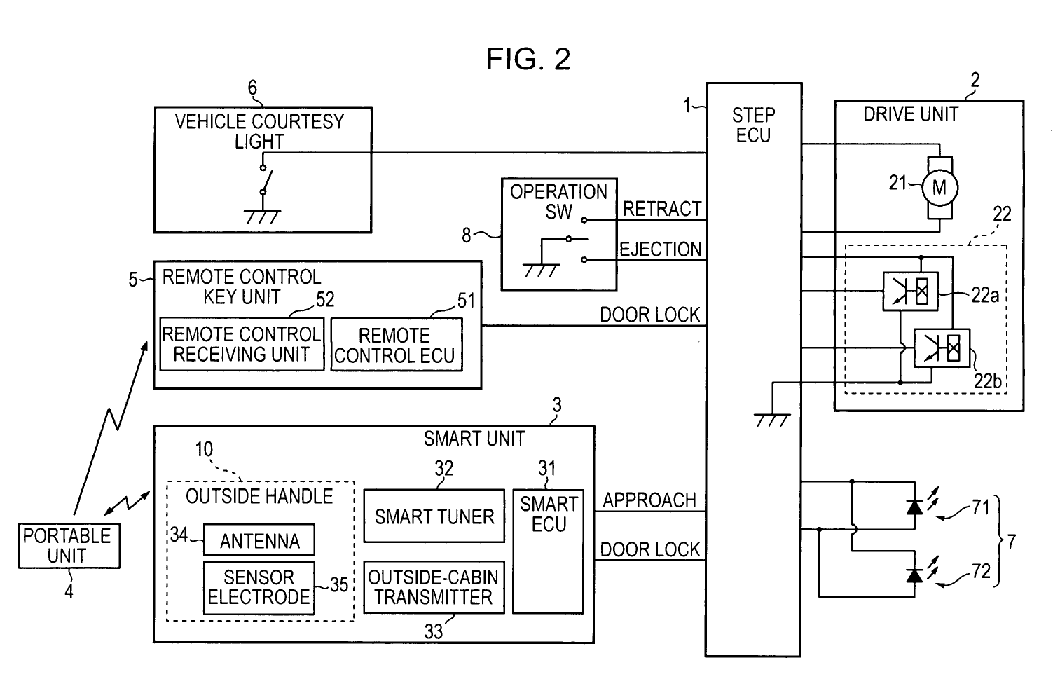

The electronically-driven step for a vehicle according to the embodiment of the present invention includes step driving means that causes the step body 9 to be ejected and retracted and step controlling means that controls the step driving means. FIG. 2 is a block diagram showing a system structure of the electronically-driven step for a vehicle according to the embodiment of the present invention including these means. Referring now to FIG. 2, the structure of the system will be described.

A step ECU (Electronic Control Unit) 1 corresponds to the step controlling means of the electronically-driven step for a vehicle in the present invention, and is a backbone of the system shown in FIG. 2. More specifically, it is composed of an electronic circuit including a microcomputer. The step ECU 1 controls ejection/retraction of the step body 9 and turning ON/OFF of the illumination device 7 in cooperation with a smart unit 3, a remote control key unit 5, and so on. The ejection/retraction of the step body 9 is executed directly by a drive unit 2 (step driving means). The step ECU 1 controls ejection/retraction of the step body 9 by controlling the drive unit 2.

The drive unit 2 includes a motor 21 and a rotation sensor 22 as shown in FIG. 2. It also includes power transmission mechanisms such as gears, restiform bodies, and so on, not shown, for transmitting a drive force of the motor 21. The rotation sensor 22 is for detecting the number of revolutions and the direction of rotation of the motor 21 or the rotating members (power transmission mechanisms, not shown) rotated by the motor 21. In this embodiment, a Hall IC is used for the rotation sensor 22, and the frequency (the number of revolutions) is measured by measuring an output pulse of the Hall IC. As shown in FIG. 2, two of Hall ICs 22a and 22b are arranged at different output phases. The direction of rotation is detected by advance or delay of the phases of the output pulses of these two Hall ICs 22a and 22b. The direction of rotation represents the direction of ejection/retraction of the step body 9.

The step body 9 includes the step illumination 71 on the upper surface thereof and the footlight 72 on the lower surface side of the step body 9 as the illumination device 7 to be controlled together with the ejection/retraction of the step body 9. The step illumination 71 serves to notify the user that the step body 9 is ejected in dark places such as during the nighttime or in the indoor parking. The footlight 72 serves to allow the user to view the state of the ground such as paddles, muddy ground, or steps easily in the dark place.

The illumination device 7 includes an LED (light-emitting diode), and hence power consumption is low and duration of life time is long. The step illumination 71 must simply emit light to an extent that enables the user to view the position of the step body 9 in the dark place. The light intensity of illumination of the footlight 72 can be reduced in comparison with the case of being installed in other places since it illuminates the direction of the ground from the position near the ground. Therefore, from this point of view, the power consumption of the illumination device 7 can be lowered.

The step ECU 1 operates the drive unit 2 for causing the step body 9 to be ejected and retracted, and controls turning ON and OFF of the illumination device 7. Activation of control is performed on the basis of the output from the smart unit 3 or the remote control key unit 5. Although it will be described in detail later, the smart unit 3 corresponds to portable unit recognizing means or lock/unlock instruction recognizing means of the present invention, and the remote control key unit 5 corresponds to the lock/unlock instruction recognizing means. In other words, the step ECU 1 as the step controlling means controls ejection/retraction of the step body 9 and light-emission of the illumination device 7 on the basis of the result of recognition of the portable unit recognizing means or the lock/unlock instruction recognizing means. Hereinafter, the illumination device 7 will be described as a device for emitting light in conjunction with ejection of the step body 9 unless otherwise specified.

The activation of control of the step body 9 and the illumination device 7 by the step ECU 1 can also be executed by manual operation by the user. An operation SW (switch) 8 as shown in FIG. 2 is provided in the system, and instruction for ejection or retraction is given by operating the operation SW 8.

The smart unit 3 serves as a backbone of a so-called smart entry system. The smart unit 3 includes a smart ECU 31, a smart tuner 32, an outside-cabin transmitter 33, an antenna 34, a sensor electrode 35, and so on. An unlocking operation as a representative function of the smart entry system will be described below.

The portable unit 4 carried by the user is an electronic key registered with respect to the vehicle 20. In a state in which the vehicle 20 is locked and parked, the smart ECU 31 transmits a request signal for recognizing the portable unit 4 as the electronic key. More specifically, an electric wave of the modulated request signal is transmitted toward the outside via the outside-cabin transmitter 33 and the antenna 34 provided on an outside handle 10.

When the portable unit 4 approaches the vehicle 20, the electric wave transmitted via the antenna 34 is received by a receiving system of the portable unit 4. The portable unit 4 decodes the received signal and processes the signal by a CPU or the like integrated in the portable unit 4. Then, the portable unit 4 transmits returned information such as an attribute or a registered code of the received signal. The term “attribute” here is information showing the source of the received signal, for example, “via the outside-cabin transmitter 33”. On the side of the vehicle 20, the electric wave transmitted from the portable unit 4 is received, and the smart ECU 31 confirms the attribution or the registered code or the like from the returned information, and recognizes that the portable unit 4 as the electronic key registered with respect to the vehicle 20 is approaching. Then, it assumes a door unlock instruction waiting state. In this manner, the smart unit 3 corresponds to the portable unit recognizing means of the present invention.

When the user approaches the vehicle 20 and lays his/her hand on the outside handle 10, the sensor electrode 35 provided on the outside handle 10 detects a handle operation. The sensor electrode 35 includes an electrostatic capacity sensor or the like. Then, the smart ECU 31 recognizes the door unlock instruction which has been waited for in association with the handle operation. Accordingly, an actuator (lock/unlock operating means) such as a solenoid or the like which locks or unlocks the door is activated and the door is unlocked. In this manner, the smart unit 3 corresponds also to the lock/unlock instruction recognizing means of the present invention.

The remote control key unit 5 which recognizes the lock/unlock instruction issued by operating a lock/unlock switch (remote control key) of the portable unit 4 also corresponds to lock/unlock recognizing means of the present invention. As shown in FIG. 2, the remote control key unit 5 is provided with a remote control ECU 51 and a remote control receiving unit 52. The lock/unlock instruction received by the remote control receiving unit 52 is recognized by the remote control ECU 51.

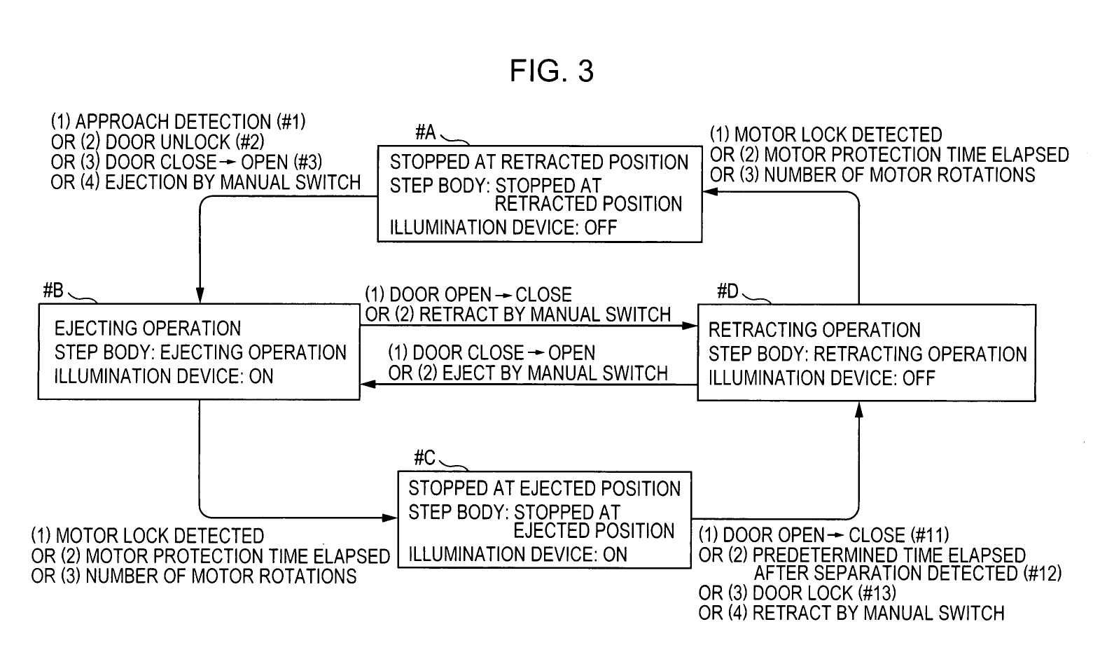

Referring also a state transition drawing in FIG. 3, control by the step ECU 1 executed on the basis of the result of recognition by the smart unit 3 or the remote control key unit 5 will be described in detail. In FIG. 3, #A-#D designate respectively states of “STOPPED AT RETRACTED POSITION (#A)”, “EJECTING OPERATION (#B)”, “STOPPED AT EJECTED POSITION (#C)”, and “RETRACTING OPERATION (#D)” of the step body 9. Then, arrows which connect the respective states represent transition between the respective states. The respective arrows have state transition conditions corresponding to those arrows written nearby. The state transition conditions shown for one arrow are “logical OR condition” which means that at least one of those conditions must be satisfied unless otherwise specified in the following description.

The step ECU 1 activates the drive unit 2 so as to cause the step body 9 to be ejected when the result that the approach of the user carrying the portable unit 4 is detected is transmitted from the smart unit 3. The step illumination 71 and the footlight 72 are also illuminated. The smart unit 3 here corresponds to the portable unit recognizing means of the present invention. Therefore, the step ECU 1 (step controlling means) controls ejection of the step body 9 on the basis of the recognized result (detection of approach) of the portable unit recognizing means. It corresponds to the state transition conditions in #1 shown in FIG. 3.

The step ECU 1 can detect the handle operation by the user in a state in which the smart unit 3 recognizes the approach of the portable unit 4 for executing the same control. In other words, it is also possible to detect the handle operation by the user as described above, and execute the same control on the basis of the door unlock instruction recognized in association with the detection. In this case, the smart unit 3 functions as the lock/unlock instruction recognizing means and the step ECU 1 controls ejection of the step body 9 on the basis of the result of recognition of the lock/unlock instruction recognizing means (door unlock instruction). It corresponds to the state transition conditions of #2 shown in FIG. 3. This may be considered to be the state transition conditions which are established by combining #1 and #2.

The same control can be executed by using the remote control key unit 5 as the lock/unlock instruction recognizing means. In this case as well, this corresponds to the state transition conditions in #2 shown in FIG. 3.

There is also a case in which a door locking mechanism (not shown) is operated by a lock/unlock instruction generated by mechanical operation by an operating unit provided in the cabin or a key (both not shown). By providing a lock/unlock operation recognizing unit that recognizes the mechanical operation, the same control as described above can be executed on the basis of a signal from the lock/unlock operation recognition unit. In this case, the lock/unlock operation recognition unit serves as the lock/unlock instruction recognizing means.

Although it will be described in detailed later, the step ECU 1 may control ejection (and retraction) of the step body 9 on the basis of the recognized results of both of the portable unit recognizing means and the lock/unlock instruction recognizing means. For example, when the vehicle 20 has a plurality of step bodies 9, it is possible to control one of the step bodies 9 on the basis of the recognized results of the portable unit recognizing means, and control the rest of the step bodies 9 on the basis of the recognized result of the lock/unlock instruction recognizing means.

The smart unit 3 can also recognize that from which direction of the vehicle the portable unit 4 is approaching. More specifically, an electric wave which contains attributes corresponding to a plurality of doors of the vehicle 20 added thereto is transmitted to the outside of the vehicle from the antenna 34 at each door. The portable unit 4 transmits the return information including the attributes or the registered code added to the received signal as described above. On the side of the vehicle 20, the electric wave transmitted from the portable unit 4 is received, and the smart ECU 31 confirms the attributes or the registered code from the returned information. Accordingly, from which direction the portable unit 4 as the electronic key corresponding to the vehicle 20 is approaching is recognized. In other words, the corresponding door is determined by the aforementioned attribute and the direction of approach (to which door it is approaching) is recognized thereby.

The step ECU 1 which receives information about the approach of the portable unit 4 and the direction of approach thereof executes control to cause the step body 9 provided on the door to which the portable unit 4 is approaching to be ejected. When the step bodies 9 are provided on a plurality of positions of the vehicle 20, if all the step bodies 9 are controlled to be ejected or retracted even when there is only one user, it is not preferable from the viewpoint of the power consumption. However, this problem is alleviated by controlling the step body 9 according to the direction of approach of the portable unit 4.

It is also possible to control other step bodies 9 to be ejected upon recognition of an unlock instruction given by the fact that the user touches the sensor electrode 35 on the outside handle 10 in a state in which the approach of the portable unit 4 is recognized. In other words, when the vehicle 20 is used by a plurality of users, the step body 9 on the side of the driver's seat is caused to be ejected first by the approach of the user (driver) carrying the portable unit 4. Then, at the time when the vehicle 20 is unlocked by the driver, other step bodies 9 are caused to be ejected. In this arrangement, all the step bodies 9 are not ejected only by the approach of the user, but the remaining step bodies 9 are ejected according to the unlock instruction. Therefore, in such a case that the driver approaches the vehicle, but does not unlock the vehicle, that is, when he/she just passes nearby, only the step body 9 on the side of the driver's seat is ejected. Consequently, excessive ejecting operation is preferably prevented.

It is also possible to adapt to control the step body 9 corresponding to the door provided on the side where the user carrying the portable unit 4 are approaching on the basis of the recognized result of the portable unit 4 by the smart unit 3, and control other step bodies 9 on the basis of the recognized result of the remote control key unit 5.

Since the control of the step body 9 which corresponds to the door provided on the side where the user carrying the portable unit 4 approaches is the same as the description above, it will not be repeated here again. Control of other step bodies 9 is executed as follows. When the lock/unlock switch (remote control key) provided with the portable unit 4 according to the present embodiment is operated once, the door of the driver's seat (or in the direction of approach) is unlocked. When it is operated consecutively twice, doors for all the seats are unlocked. When the user carrying the portable unit 4 operates the remote control key twice, the unlock instruction is given for doors for all the seats. The remote control key unit 5 recognizes this unlock instruction, and transmits the result to the step ECU 1. The step ECU 1 controls ejection of the step body 9 on the basis of the recognized result of the unlock instruction.

In this manner, it is also possible to execute control corresponding to the respective doors of the vehicle 20 by combining the recognition by the smart unit 3 and the recognition by the remote control key unit 5.

When the plurality of step bodies 9 are provided for the plurality of doors of the vehicle 20, it is also possible to adapt so that locking and unlocking of each door or ejection and retraction of the step body 9 can be set in advance. For example, it may be adapted to be capable of selecting whether to cause only one of the step bodies 9 to be ejected on the basis of the recognized result of the portable unit recognizing means or to cause all the step bodies 9 to be ejected. It is because convenience is different depending on the place of destination or the way of usage of the user. The term “place of destination” here means different countries or, even in the same country, different regions having climates different from each other. The term “the way of usage of the user” includes whether the vehicle is often used by a plurality of persons or is often used by a single person. The timing of advance setting may be in a manufacturing plant or in a sales agent, or it may be set by the user.

Control when the step body 9 is retracted will be described below. As described above, the ejection control of the step body 9 is executed with the vehicle 20 locked, and the door is opened and the user gets on the vehicle after the vehicle 20 is unlocked. In this embodiment, as shown in FIG. 2, the step ECU 1 receives an input from a vehicle courtesy 6 transmitted thereto. The vehicle courtesy 6 outputs signals indicating an open/close state of the vehicle door, and corresponds to open/close state detection means in the present invention. When the door is opened, this information is transmitted to the step ECU 1.

The step ECU 1 controls ejection/retraction of the step body 9 on the basis of transition between the ejected and retracted states of the step body 9 and between the open and close states of the vehicle door. For example, in a state in which the step body 9 is ejected, it is assumed that the vehicle door which corresponds to this step body 9 is changed from the opened state to the closed state. In this case, it is determined that getting on and off will not be performed any more since the vehicle door is closed. Therefore, the step ECU 1 controls to cause the step body 9 to be retracted. In association therewith, the illumination device 7 (71, 72) is turned off. Hereinafter, the illumination device 7 is turned off in association with the retraction of the step body 9 unless otherwise specified. This corresponds to the state transition conditions in #11 shown in FIG. 3.

As described above, radio communication is performed between the portable unit 4 and the smart unit 3. When the portable unit 4 approaches the vehicle 20, the smart ECU 31 recognizes that the user is approaching as described above. Then, on the basis of this recognized result, the step ECU 1 causes the step body 9 to be ejected. Then, when the user moves apart from the vehicle 20 without getting on the vehicle 20, the smart unit 3 cannot receive the electric wave transmitted from the portable unit 4 any longer. Accordingly, the smart ECU 31 recognizes that the portable unit 4 moved apart from the vehicle 20. When it recognizes the separation, it is transmitted to the step ECU 1. The step ECU 1 activates the drive unit 2 so as to drive the step body 9 to be retracted on the basis of the recognized result. In association therewith, the illumination device 7 (71, 72) is turned off.

However, the reason why the smart unit 3 cannot receive the electric wave from the portable unit 4 depends not only on the distance between the both sides. It also depends on variations in output of the portable unit 4 or existence of object or medium which blocks transmission of the electric wave between the both sides. Therefore, it is not preferable to control ejection/retraction of the step body 9 or turning ON and OFF of the illumination device 7. In other words, there arise cases such that the step body 9 repeats ejection and retraction discontinuously, or that the illumination device 7 flickers. If it happens, the user may be confused and an excessive load is exerted to the motor 21 and the like.

In the present embodiment, in order to alleviate the problem, control such that the step body 9 is retracted after a predetermined time is elapsed after having recognized separation of the portable unit 4 and the illumination device 7 is turned off is executed. With this control, even when it is recognized as separation once, if the electric wave is received again immediately, measurement of the predetermined time is cleared, and hence the above-described problem can be alleviated. The retraction control of the step body 9 using the smart entry system has been described thus far, which corresponds to the state transition conditions in #12 shown in FIG. 3.

It is also possible to add control for the case in which the user carrying the portable unit 4 stays around the vehicle 20 and has no will to get thereon. When a second predetermined time is elapsed without recognition of the unlock instruction after having caused the step body 9 to be ejected on the basis of the recognition of approach of the portable unit 4, the step ECU 1 may determine that the user has no will to get on the vehicle and retract the step body 9.

Subsequently, a case of the state transition condition “DOOR LOCK” in #13 shown in FIG. 3 will be described. The conditions of retraction in response to the door lock using the smart entry system will be described.

When the user is in the cabin, the portable unit 4 carried by the user is also in the cabin. At this time, the portable unit 4 receives the request signal transmitted from an inside-cabin transmitter antenna (not shown) arranged in the cabin. Then, the portable unit 4 processes the received signal like in the outside, and transmits the returning information such as the attribute and the registered code of the received signal. The electric wave transmitted from the portable unit 4 is received in the cabin, and the smart unit 3 confirms the received information and recognizes that the portable unit 4 is in the cabin.

In this state, when the user gets off the vehicle with the portable unit 4 carried and closes the door, the above-described communication in the cabin is discontinued. Then, the smart unit 3 recognizes that the portable unit 4 is moved from the cabin to the outside of the cabin. In addition, it is also possible to adapt to confirm that the outside-cabin communication can be established.

When the fact that the user has gotten off the vehicle and the door has closed is confirmed (using the output from the vehicle courtesy 6), the smart unit 3 is changed to a door lock detection mode. The outside handle 10 is provided with a locking operation instruction unit used also as the sensor electrode 35, or additionally. When the user performs an operation such as pushing the locking operation instruction unit with his/her finger or the like, this operation is transmitted to the smart unit 3. The smart unit 3 recognizes the LOCK instruction. Then, the recognized result is transmitted from the smart unit 3 to the step ECU 1. The step ECU 1 causes the step body 9 to be retracted on the basis of the recognized result. At this time, the smart unit 3 functions as the lock/unlock instruction recognizing means or both as the portable unit recognizing means and the lock/unlock instruction recognizing means.

In the case in which the door lock of the vehicle 20 is achieved by remote control using the remote control key (portable unit 4) as well, the step body 9 can be retracted. The remote control key unit 5 recognizes the LOCK instruction, and transmits the same to the step ECU 1. The step ECU 1 controls the step body 9 to be retracted on the basis of the recognized result. In this case, the remote control key unit 5 functions as the lock/unlock instruction recognizing means.

It is also possible to adapt to determine that the user has no will to get on the vehicle when a third predetermined time has elapsed after the door of the vehicle 20 is unlocked using the smart unit 3 or the remote control unit 5, and retract the step body 9. In general, in a vehicle self-locking control, when information that the door is opened cannot be obtained from the vehicle courtesy 6 after the unlocking operation, the door is controlled to be locked again after a predetermined time is elapsed. It is also possible to determine this relock instruction as the LOCK instruction, and cause the step body 9 to be retracted by recognizing this instruction. In this manner, not only the smart unit 3 or the remote control unit 5, but also various devices can be used as the lock/unlock instruction recognizing means.

There is a case in which a door locking mechanism (not shown) is operated by the lock/unlock instruction generated by the mechanical operation by the operating unit provided in the cabin or the key (both not shown). In this case, the retraction control as in the description above is enabled also by recognizing the mechanical operation.

Description on the transition conditions for terminating the operation state in a state in which ejection or retraction is in operation (#B, #D in FIG. 3) is added below. The transition conditions are common as shown in FIG. 3. The drive unit 2 is provided with the rotation sensor 22 in addition to the motor 21. The number of rotations of the motor 21 can be known in association with the action of ejection or retraction by the rotation sensor 22. Then, when the number of rotations required for ejection and retraction are reached, the rotation of the motor 21 is stopped, and the step body 9 is brought into a stopped state (#A, #C in FIG. 3).

It is also possible to detect the fact that the step body 9 is fixed and hence the rotation of the motor 21 is stopped, that is, motor lock, not by the number of rotations, but by the fact that the step body 9 reaches the ejected position or the retracted position. In this case, it may be determined together with measurement of the above-described number of rotations. In other words, it may be determined that the step body 9 has reached a correct ejected position or the retracted position when the motor is rotated by a predetermined number of rotations and locked.

Alternatively, it is possible to define a standard time required for ejection and retraction, and stop the motor 21 when the standard time is exceeded. For example, when a foreign substance hinders the step body 9 from being ejected or retracted, there may be a case in which the motor 21 is not locked and rotates at a very low speed. In this case, an excessive load is applied to the motor 21 for a long time, and hence increase of the power consumption or failure of the motor 21 may be resulted. Therefore, it is preferable to define the standard time required for ejection and retraction, and stop the ejection and retraction control of the step body 9 when exceeding the standard time. In this case as well, by employing the result of measurement of the number of rotations, determination including whether or not the step body 9 reaches the correct ejected or retracted position within the standard time can be achieved.

Although not shown in the drawing, it is also possible to provide a position sensor for detecting the position of ejection or retraction and detect whether or not the step body 9 is located at the ejected and retracted positions.

Between the states #B and #D in FIG. 3, the state is changed according to an operation of a manual SW or the open/close state of the doors since it is considered to be preferable to reverse the ejecting/retracting operation respectively, for example, when the door is closed in the course of the ejecting operation or the door is opened in the course of the retracting operation. In other words, when the door is closed in the course of the ejecting operation, it is considered that the user stops getting on or off, and hence it is not necessary to eject the step body 9. On the other hand, when the door is opened in the course of the retracting operation, it is considered that the user has a will to get on or off, and hence it is preferable to cause the step body 9 to be ejected. It is the same in the case of giving instruction of transition of the state by the manual operation SW8.

As described above, the electronically-driven step for a vehicle which is convenient for the user of the vehicle is provided by the present invention.

What is claimed is:

1. An electronically-driven step for a vehicle comprising:
a step body which can be ejected and retracted between an ejected position projecting outwardly from a side surface of a vehicle body of the vehicle and a retracted position retracted inwardly of the side surface thereof;
a portable unit recognizing device that recognizes movement of at least the portable unit toward the vehicle or apart from the vehicle;
a step driving device that causes the step body to be ejected or retracted; and
a step controlling device that controls the step driving device,
wherein the step controlling device controls ejection and retraction of the step body on the basis of a recognized result of the portable unit recognizing device.

2. An electronically-driven step for a vehicle comprising:
a step body which can be ejected and retracted between an ejected position projecting outwardly from a side surface of a vehicle body and a retracted position retracted inwardly of the side surface of the vehicle body thereof;
a lock/unlock operating device that locks or unlocks a vehicle door;
a lock/unlock instruction recognizing device that recognizes an instruction for the lock/unlock operating device;
a step driving device that causes the step body to be ejected or retracted; and
a step controlling device that controls the step driving device,
wherein the step controlling device controls ejection and retraction of the step body on the basis of a recognized result of the lock/unlock instruction recognizing device.

3. The electrically-driven step for a vehicle according to claim 1 comprising: the lock/unlock operating device that locks or unlocks the vehicle door and the lock/unlock instruction recognizing device that recognizes the instruction for the lock/unlock operating device,
wherein the step controlling device controls ejection and retraction of the step body on the basis of the recognized result or results of one or both of the portable unit recognizing device and the lock/unlock instruction recognizing device.

4. The electrically-driven step for a vehicle according to claim 1, wherein the step body is adapted to be ejected when the fact that the portable unit is approaching the vehicle is recognized and to be retracted when the portable unit is moved apart from the vehicle is recognized.

5. The electrically-driven step for a vehicle according to claim 3, wherein the step body is adapted to be ejected when the fact that the portable unit is approaching the vehicle is recognized and to be retracted when the portable unit is moved apart from the vehicle is recognized.

6. The electrically-driven step for a vehicle according to claim 4, wherein the portable unit recognizing device detects the direction in which the portable unit is approaching, and the step controlling device causes the step body provided on the side where the portable unit is approaching to be ejected.

7. The electrically-driven step for a vehicle according to claim 5, wherein the portable unit recognizing device detects the direction in which the portable unit is approaching, and the step controlling device causes the step body provided on the side where the portable unit is approaching to be ejected.

8. The electrically-driven step for a vehicle according to claim 4, wherein the step body is retracted after having elapsed a predetermined time period after the fact that the portable unit is moved apart from the vehicle is recognized.

9. The electrically-driven step for a vehicle according to claim 5, wherein the step body is retracted after having elapsed a predetermined time period after the fact that the portable unit is moved apart from the vehicle is recognized.

10. The electrically-driven step for a vehicle according to claim 6, wherein the step body is retracted after having elapsed a predetermined time period after the fact that the portable unit is moved apart from the vehicle is recognized.

11. The electrically-driven step for a vehicle according to claim 7, wherein the step body is retracted after having elapsed a predetermined time period after the fact that the portable unit is moved apart from the vehicle is recognized.

12. The electrically-driven step for a vehicle according to claim 3, wherein the portable unit recognizing device detects the direction in which the portable unit is approaching, and
the step controlling device causes the step body provided on the side where the portable unit is approaching to be ejected on the basis of the detected direction, and causes other step bodies to be ejected on the basis of the recognition of an unlock instruction from the lock/unlock instruction recognizing device.

13. The electronically-driven step for a vehicle according to claim 2, wherein the step body is caused to be ejected when the lock/unlock instruction recognizing device recognizes an unlock instruction, and caused to be retracted when the same recognizes a lock instruction.

14. The electronically-driven step for a vehicle according to claim 3, wherein the step body is caused to be ejected when the lock/unlock instruction recognizing device recognizes an unlock instruction, and caused to be retracted when the same recognizes a lock instruction.

15. The electrically-driven step for a vehicle according to claim 1, further comprising: an open/close state detecting device that detects an open/close state of the respective vehicle doors, wherein the step controlling device causes the corresponding step body to be retracted according to a transition from the open state to the close state of each door.

16. The electrically-driven step for a vehicle according to claim 2 further comprising: an open/close state detecting device that detects an open/close state of the respective vehicle doors, wherein the step controlling device causes the corresponding step body to be retracted according to a transition from the open state to the close state of each door.

17. The electrically-driven step for a vehicle according to claim 4 further comprising: an open/close state detecting device that detects an open/close state of the respective vehicle doors, wherein the step controlling device causes the corresponding step body to be retracted according to a transition from the open state to the close state of each door.

18. The electrically-driven step for a vehicle according to claim 1 further comprising an illumination device, wherein the illumination device is illuminated in conjunction with the step body being ejected.

19. The electrically-driven step for a vehicle according to claim 2 further comprising an illumination device, wherein the illumination device is illuminated in conjunction with the step body being ejected.

20. The electrically-driven step for a vehicle according to claim 4 further comprising an illumination device, wherein the illumination device is illuminated in conjunction with the step body being ejected.
